(19) United States
(12) Patent Application Publication
(10) Pub. No.: US 2016/0093082 A1
(43) Pub. Date: Mar. 31, 2016

(54) IMAGE RENDERING DEVICE AND IMAGE RENDERING PROGRAM

(71) Applicant: DeNA Co., Ltd., Tokyo (JP)

(72) Inventor: Kazutaka ERA, Tokyo (JP)

(21) Appl. No.: 14/868,152

(22) Filed: Sep. 28, 2015

(30) Foreign Application Priority Data
Sep. 29, 2014 (JP) 2014-198490

(51) Int. Cl. G06T 11/60; G06T 15/50

(52) U.S. Cl. CPC G06T 11/60; G06T 15/503

(57) ABSTRACT

An image rendering device that renders an image by combining multiple image objects that are represented by superimposing multiple image elements having a preset rendering order, wherein rendering is performed using the same rendering process by compiling image elements that satisfy a combination of rendering conditions, which allow for rendering using the same rendering process as the above-mentioned multiple image objects.

### IMAGE RENDERING DEVICE AND IMAGE RENDERING PROGRAM

The present application claims the benefit of Japanese Patent Application No. JP2014-198490, filed on Sep. 29, 2014, the content of which is incorporated herein in its entirety by reference.

### BACKGROUND

1. Technical Field

The present invention relates to an image rendering device and an image rendering program (e.g., non-transitory computer readable medium having machine-executable instructions with which a computer having a storage and a hardware processor).

2. Related Art

When images are rendered in electronic games and the like, a method is used wherein multiple image objects obtained by superimposing multiple partial images (image elements) are combined and rendered as a single image in accordance with a predetermined rendering order.

FIG. 7 illustrates an example in which multiple image elements are superimposed using alpha-blending and displayed as a single image object. The image object is rendered by invoking (calling) a process by which image elements A0 to A3 are sequentially rendered based on predetermined rendering conditions (alpha-blending settings) in accordance with a rendering order represented by graph nodes in FIG. 8. Furthermore, when rendering an image having 25 image objects displayed side by side as shown in FIG. 9 (i.e., image objects P0 to P24 lined up from the upper left corner towards the bottom right corner), the rendering process is carried out in sequence for image objects P0 to P24 in accordance with the rendering order represented by the graph nodes illustrated in FIG. 10, such that a rendering process is sequentially invoked (called) for image elements A0 to A3, which constitute image object P0, after which the same is done for image elements B0 to B3, which constitute image object P1, and so on.

### Problems to Be Solved by the Invention

Incidentally, as images become more complicated, the number of image objects contained in an image used to display a single screen as well as the number of image elements that constitute each image object increases. For this reason, the frequency of calls used to render an entire image increases and, as a result, the time required for the rendering process increases. In particular, in situations where large numbers of image objects having animation effects applied thereto are displayed with the same timing in electronic games and the like, the frequency of calls to the rendering process increases and rendering may slow down.

### SUMMARY

It is an object of the present invention to provide an image rendering device and an image rendering program (e.g., non-transitory computer readable medium having machine-executable instructions with which a computer having a storage and a hardware processor) capable of shortening the processing time required for rendering an image by reducing the frequency of invoking (calling) the rendering process used during image rendering.

One aspect of the present invention is an image rendering device that renders an image by combining multiple image objects that are represented by superimposing multiple image elements having a preset rendering order, wherein said image rendering device performs rendering using the same rendering process by compiling image elements that satisfy a combination of rendering conditions, which allow for rendering using the same rendering process as the above-mentioned multiple image objects (e.g., by compiling image elements that satisfy a combination of rendering conditions, which allow for the rendering using the rendering process that is the same as the respective rendering processes for the multiple image objects).

Another aspect of the present invention is an image rendering program (e.g., non-transitory computer readable medium having machine-executable instructions with which a computer having a storage and a hardware processor) that renders an image by combining multiple image objects that are represented by superimposing multiple image elements having a preset rendering order, wherein said image rendering program directs a computer to operate as an image rendering means that performs rendering using the same rendering process by compiling image elements that satisfy a combination of rendering conditions, which allow for rendering using the same rendering process as the above-mentioned multiple image objects (e.g., by compiling image elements that satisfy a combination of rendering conditions, which allow for the rendering using the rendering process that is the same as the respective rendering processes for the multiple image objects).

Here, the rendering conditions preferably include at least one of texture rendering conditions, alpha-blending rendering conditions, and color-blending rendering conditions.

In addition, the image is rendered preferably such that the rendering order of the multiple image elements contained in each of the multiple image objects is maintained intact.

### Effects of the Invention

In accordance with the present invention, the processing time required for rendering an image is shortened by reducing the frequency of invoking (calling) the rendering process used during image rendering.

### BRIEF DESCRIPTION OF THE DRAWINGS

FIG. 1 A diagram illustrating the configuration of an image rendering device according to an embodiment of the present invention.

FIG. 2 A diagram illustrating the configuration of image graph nodes according to an embodiment of the present invention.

FIG. 3 A diagram illustrating an exemplary ordered list generated in a prior-art rendering process.

FIG. 4 A flow chart of an image rendering process according to an embodiment of the present invention.

FIGS. 5(a)-5(d) Diagrams illustrating exemplary ordered lists used to explain Example 1 of the image rendering process of the present invention.

FIGS. 6(a)-(d) Diagrams illustrating exemplary ordered lists used to explain Example 2 of the image rendering process of the present invention.

FIG. 7 A diagram illustrating an exemplary image object rendering order and rendering conditions.

FIG. 8 A diagram illustrating exemplary graph nodes indicating an image object rendering order.

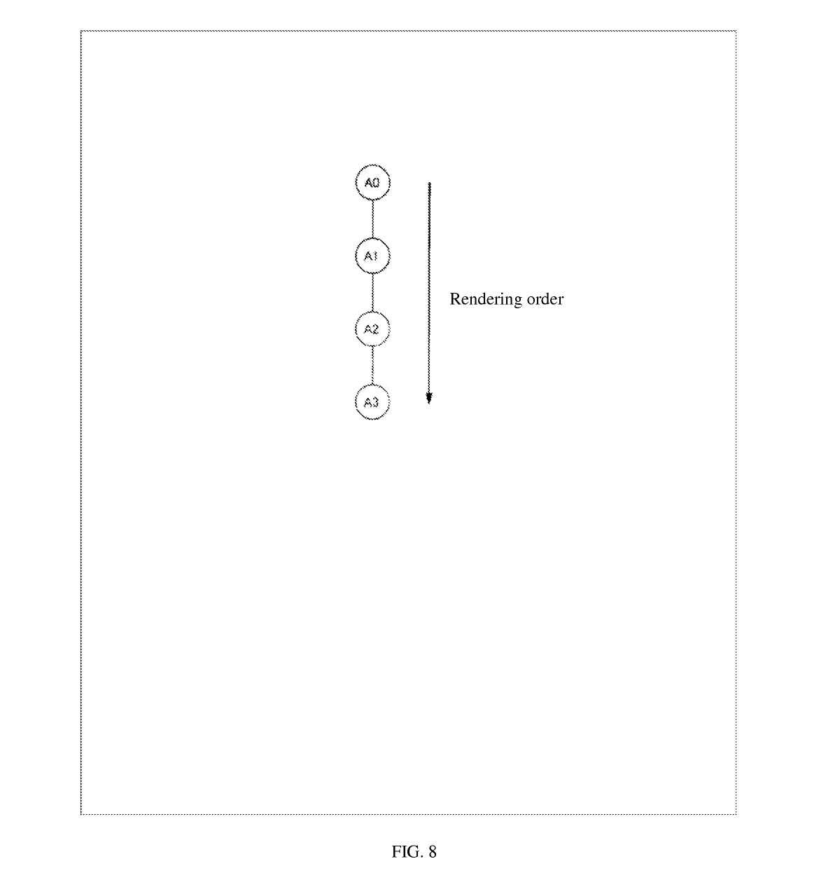

FIG. 9 A diagram illustrating an exemplary image formed by combining multiple image objects.

FIG. 10 A diagram illustrating exemplary graph nodes indicating a rendering order for an image formed by combining multiple image objects.

### DETAILED DESCRIPTION

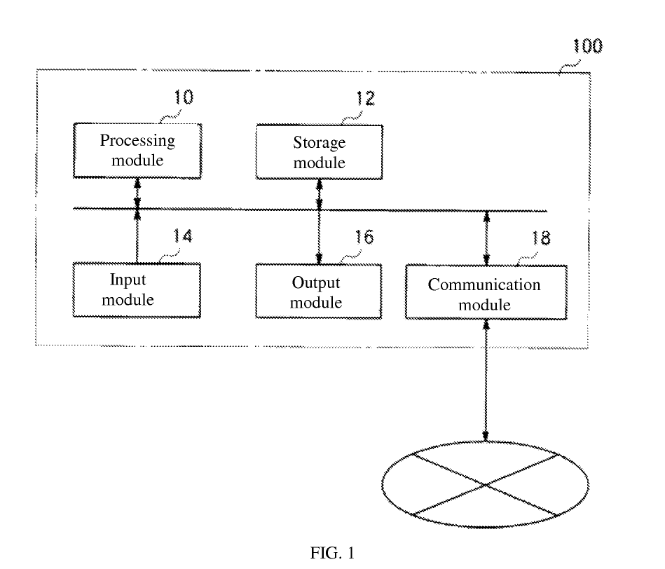

As shown in FIG. 1, the image rendering device 100 according to an embodiment of the present invention includes a processing module 10, a storage module 12, an input module 14, an output module 16, and a communication module 18. The image rendering device 100 can be implemented not only using a personal computer (PC), but also using a communication-enabled mobile terminal such as, for example, a mobile phone, a smartphone, a tablet terminal, or the like.

The processing module 10 includes means for performing arithmetic processing, such as a CPU, or the like. The storage module 12 includes storage means, such as a semiconductor memory, a memory card, or the like. The storage module 12 is accessibly connected to the processing module 10 and stores application programs (e.g., non-transitory computer readable medium having machine-executable instructions with which a computer having a storage and a hardware processor), data required for their processing, and other information. The input module 14 includes means for entering information into the image rendering device 100. The input module 14 has, for example, a touchscreen panel, or buttons and the like, for accepting input from the user. The output module 16 includes a user interface (UI) screen, or the like, used for accepting input information from the user and means for outputting processing results from the image rendering device 100. For example, the output module 16 is provided with a display for presenting images to the user. The communication module 18 includes an interface for exchanging information with other information communication devices via an information communication network 104. Communication via the communication module 18 may be either wired or wireless.

In this embodiment, an electronic game is provided to the user by executing an electronic game program (e.g., non-transitory computer readable medium having machine-executable instructions with which a computer having a storage and a hardware processor) in the processing module 10. Since the display of the game screens displayed on the output module 16 is modified as the electronic game progresses, an image rendering process is implemented by executing an image rendering program (e.g., non-transitory computer readable medium having machine-executable instructions with which a computer having a storage and a hardware processor) at such time.

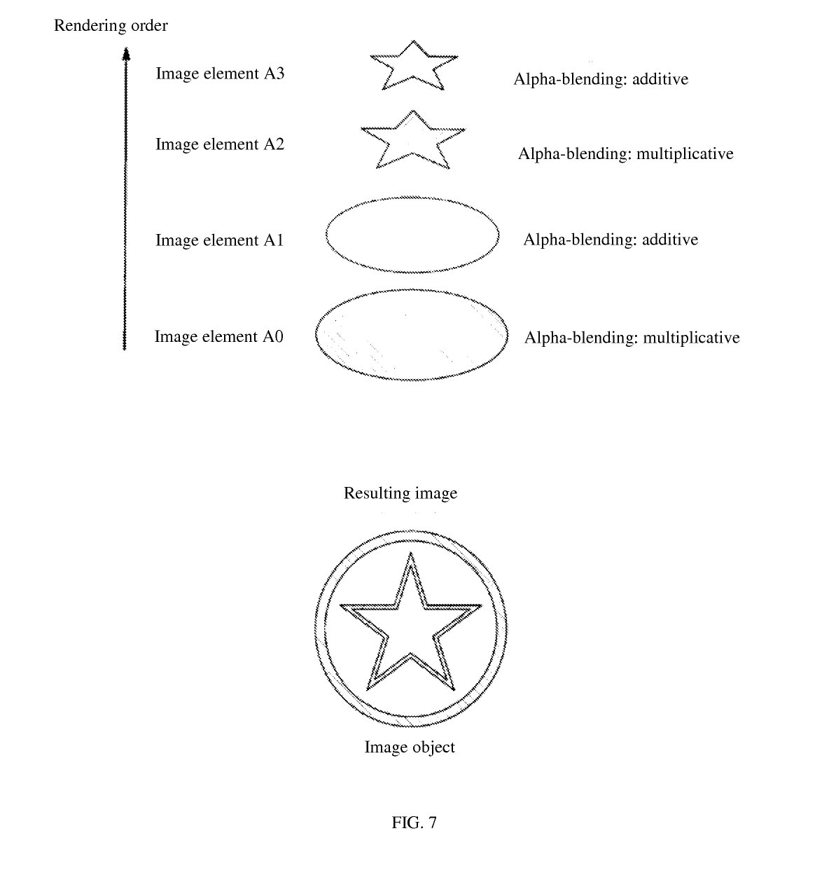

The image rendering process is carried out by appropriately placing multiple image objects that are represented by superimposing multiple image elements on the screen as shown in FIG. 7 and rendering them. In the course of image processing in this embodiment, rendering is performed by compiling image elements that satisfy a combination of rendering conditions, which allow for rendering by invoking (calling) the same rendering process, in other words, a single rendering process, in multiple image objects.

Here, the rendering conditions that are to be considered on determining whether rendering using the same rendering process is possible preferably include at least one of texture-rendering conditions, alpha-blending rendering conditions, and color-blending rendering conditions. In addition, images are rendered such that, in each of the multiple image objects, the rendering order of the multiple image elements included in each image object is maintained intact.

The term “alpha-blending” refers to a process that blends multiple image elements based on a coefficient (alpha-value). In the rendering of images in electronic games, in particular, alpha-blending is used when, for example, blending separately drawn background image elements and character image elements. In addition, it is used for the anti-aliasing of symbol-like image elements and the like. During the blending process, ancillary data defining information on pixels that one would like to make translucent, which is called the alpha channel, is prepared and areas that one would like to make translucent are made translucent in images that are superimposed based on this data. The alpha channel may also be any given color in the image that one would like to make translucent.

The term “texture” refers to a process during which image elements that are used to represent surface patterns, textures, and the like are applied to other image elements. In some cases the image elements themselves used to represent surface patterns, textures, and the like are referred to as “textures”. The action of applying textures to other image elements is called texture mapping.

The term “color blending” refers to the blending of the colors of multiple superimposed image elements. Color blending involves rendering performed by changing the mutual interaction between the colors of the image elements that are the base colors (base colors) and the colors of the image elements to be superimposed (blended colors), depending on the rendering mode. For example, in standard color blending, the blended colors do not interact with the base colors and the base colors in superimposed rendered areas are painted over with the blended colors. In multiplicative color blending, final colors are obtained by merging the base colors with the blended colors. The final colors become darker than the base colors and blended colors. Screen color blending involves merging colors obtained by inverting the blended colors and base colors. The final colors become lighter than the base colors and blended colors.

However, the rendering conditions under consideration are not limited thereto and may be any rendering conditions in accordance with which rendering by invoking (calling) the same rendering process is made impossible if the conditions are not matched.

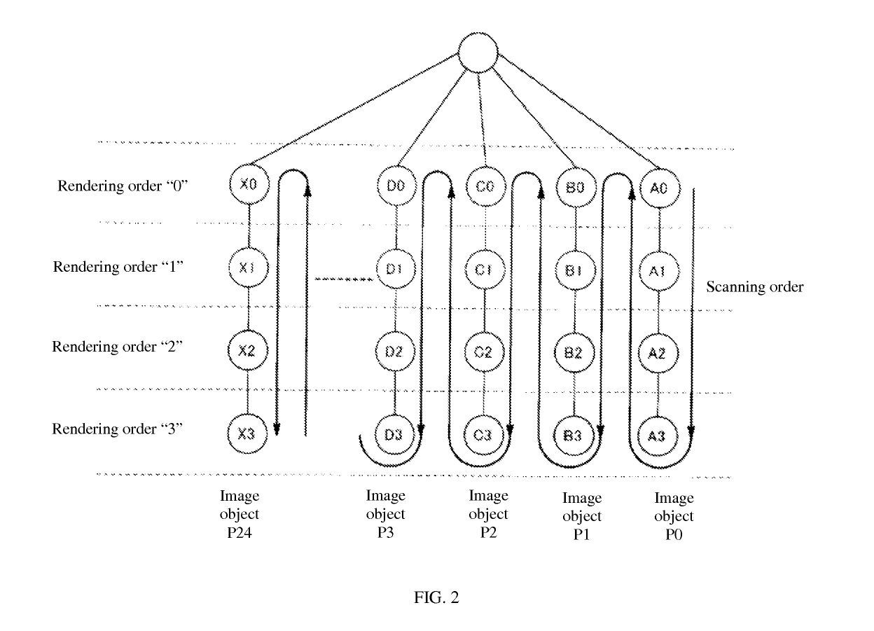

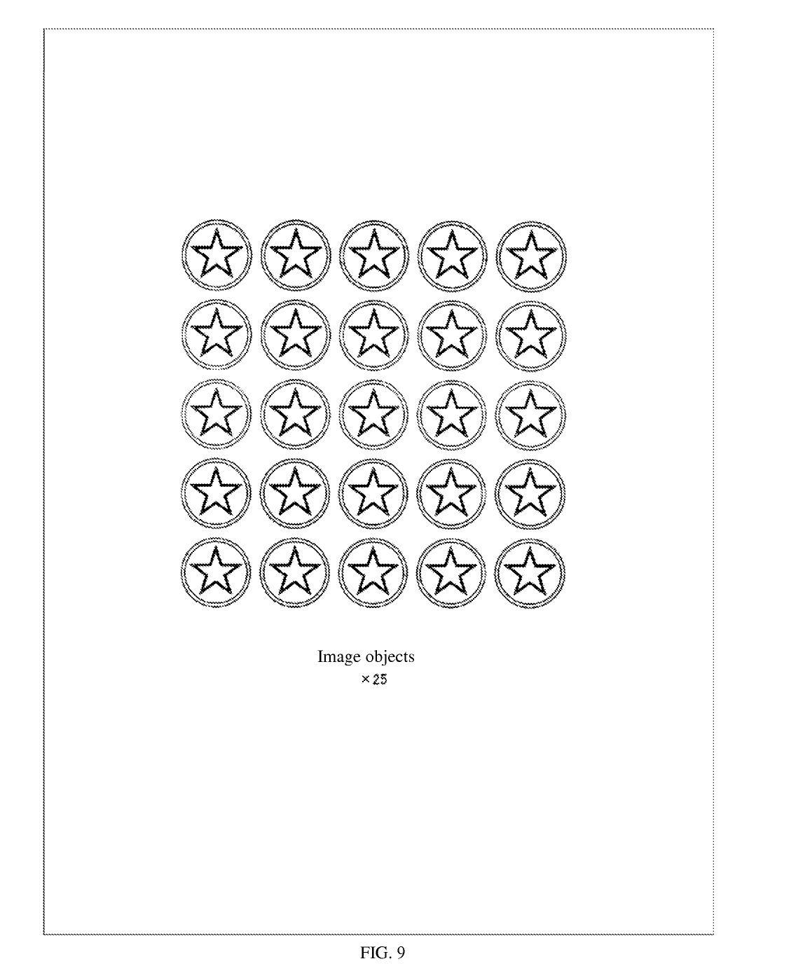

When rendering an image having 25 image objects displayed side by side as shown in FIG. 9 (i.e., image objects P0 to P24 lined up from the upper left corner towards the bottom right corner), the rendering order is represented by the graph nodes illustrated in FIG. 2. For each image object P0 to P24, the rendering order and rendering conditions of the image elements the object is composed of are determined prior to the rendering process.

Here, in every image object, the graph nodes are shown with the same numerals assigned to the image elements that are rendered in the same rendering order starting from the root node (the node corresponding to the image element rendered in the deepest background). For example, since image element A0, which forms part of image object P0, and image element B0, which forms part of image object P1, are rendered first in the respective image objects, they are assigned the same numeral “0”. The same applies to image element C0, and so on, of image object P2. In addition, since image element A1, which forms part of image object P0, and image element B1, which forms part of image object P1, are rendered second in the respective image objects, they are assigned the same numeral “1”. The same applies to image element C1, and so on, of image object P2. In this manner, a rendering order for rendering the image elements constituting each image object is recorded in said image object in the graph nodes.

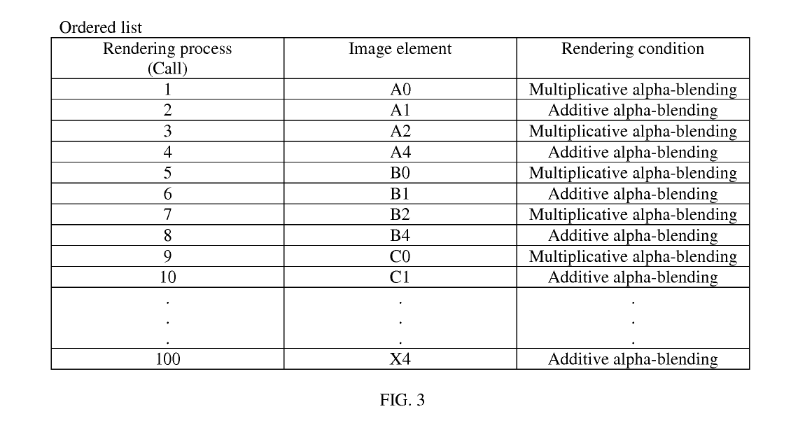

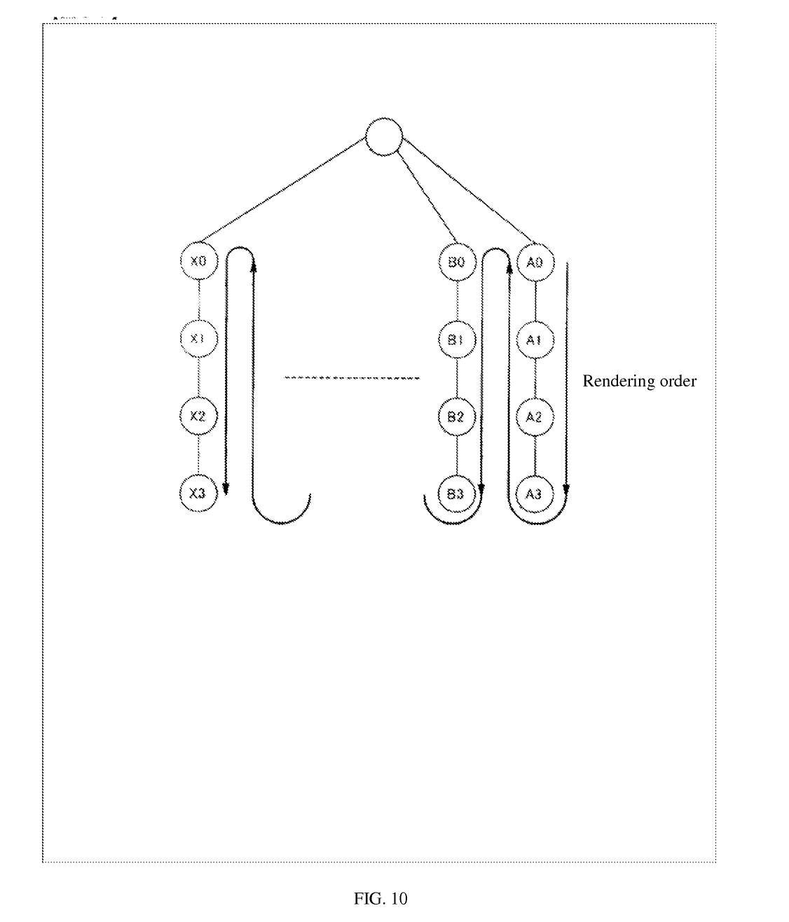

In the prior-art image rendering process, as shown in FIG. 10, image objects P0 to P24 are subjected to the rendering process in sequence such that the rendering process is sequentially invoked (called) first for the image elements A0 to A3, which constitute image object P0, and then for the image elements B0 to B3, which constitute image object P1, and so on. FIG. 3 is a diagram that represents the image element rendering order and rendering conditions as a sequence.

Here, if the rendering order and rendering conditions of the image elements that each image object P0 to P24 is composed of are modified, then the order of image superimposition, as well as alpha-blending, texture, color blending, and other conditions, will be modified and, as a result, the image being rendered will be modified as well. Accordingly, in this embodiment, in each image object P0 to P24, processing is carried out in which the frequency of invoking (calling) the rendering process is reduced by modifying the rendering order of each image element in each image object P0 to P24 without changing the rendering order and the rendering conditions of the image elements that the object is composed of; in other words, the rendering order of the multiple image elements included in each of the multiple image objects P0 to P24 is maintained intact.

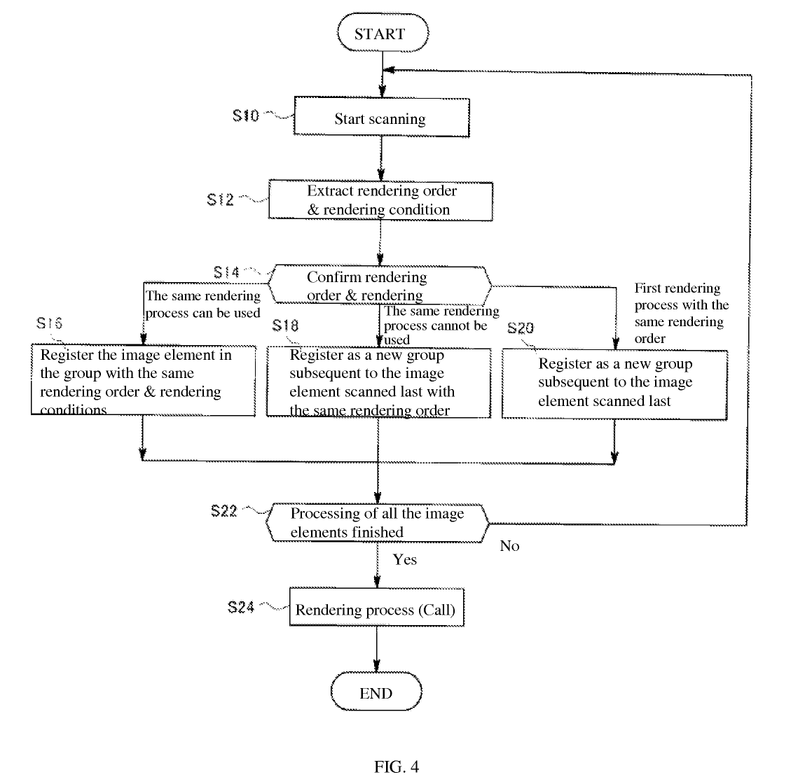

The rendering order modification process is carried out based on the rendering conditions (group) and rendering order of each image element. The image rendering process used in this embodiment will be explained below with reference to the flow chart of FIG. 4. For example, in an electronic game, the image rendering process is carried out at the moment when an event takes place, or carried out such that the screen is refreshed at regular intervals.

In Step S10, along with initiating the rendering process, the processing module 10 starts scanning graph nodes in accordance with the rendering order used in prior-art rendering processes. As a result of said scan, an ordered list is generated that shows the order of rendering of each image element.

In Step S12, the rendering order and rendering conditions of the image elements in the image object containing the image element currently being scanned are extracted.

In Step S14, it is determined whether or not there is a group belonging to image elements having the same rendering order and rendering conditions as the image element currently being scanned among the image elements that have already been scanned, in other words, whether or not there are other image elements having the same rendering conditions that can be rendered by invoking (calling) a single rendering process. In the event that a combination of rendering conditions, which allow for rendering of two image elements using the same rendering process, are satisfied, the procedure advances to Step S16, otherwise the procedure advances to Step S18. In addition, the procedure advances to Step S20 if no image elements having the same rendering order as the image element currently being scanned have been scanned in the past, in other words, if the image element currently being scanned is the first element to be scanned among the image elements having the same rendering order.

In Step S16, the image element currently being scanned and image elements belonging to the same group among the image elements having the same rendering order as the image element currently being scanned among the image elements that have already been scanned are registered in the ordered list so as to be rendered using the same rendering process.

In Step S18, the image element currently being scanned subsequent to the last image element scanned among the image elements having the same rendering order as the image element currently being scanned is registered in the ordered list so as to be rendered as a different new group. The rendering conditions of the new group are the rendering conditions of the registered image element. In other words, the image element currently being scanned and the last image element scanned among the image elements having the same rendering order as the image element currently being scanned are registered in the ordered list so as to be rendered using different rendering processes.

In Step S20, the image element currently being scanned is registered in the ordered list as a new group so as to be rendered subsequently to the last image element scanned. The rendering conditions of the new group are the rendering conditions of the registered image element.

In Step S22, it is determined whether or not the scanning of all the image elements of all the image objects subject to rendering is finished. If the scanning is over, the procedure advances to Step S24, and if it is not, the procedure goes back to Step S10 and the scanning is continued from the next image element.

In Step S24, the rendering process is carried out in accordance with the ordered list. The processing module 10 renders each image element by sequentially invoking (calling) the rendering process in accordance with the registered ordered list up to Step 22. If at such time the elements are registered in the ordered list such that multiple image elements are rendered using a single rendering process, the corresponding image elements are rendered by invoking (calling) a single rendering process.

### EXAMPLE 1 OF IMAGE RENDERING PROCESS

The following discussion refers to an example in which the image rendering process according to the present embodiment is applied to the graph nodes of FIG. 2.

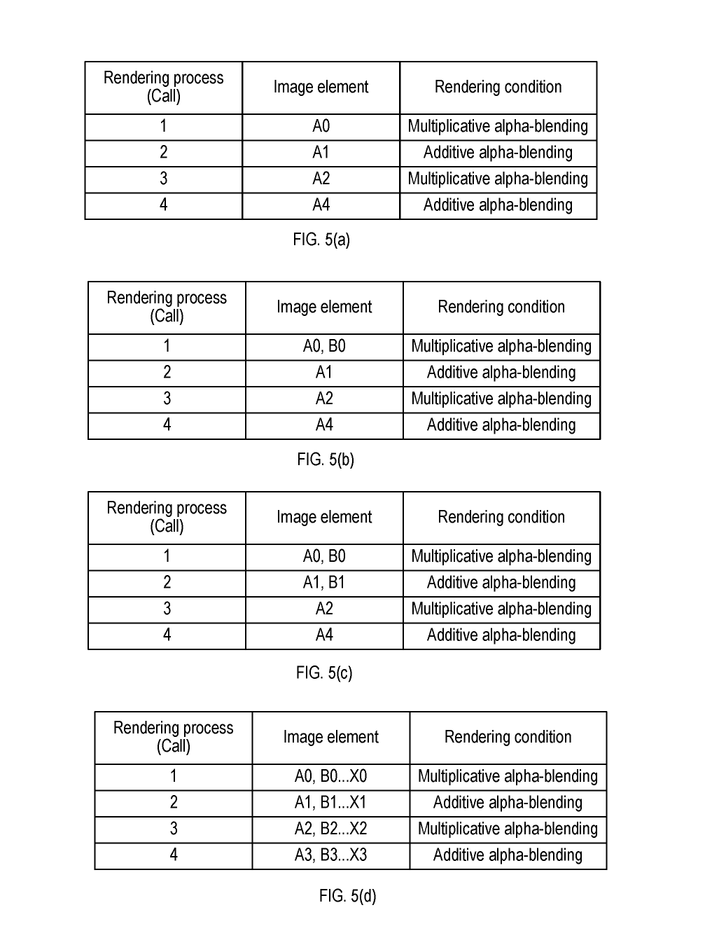

First, in Step S10, image element A0 of image object P0 is configured as the target to be scanned. In Step S12, “0” is extracted as the rendering order and “multiplicative alpha-blending” is extracted as the rendering condition of image element A0 of image object P0. In Step S14, due to the fact that image element A0 currently being scanned is the first element to be scanned among the image elements having the same rendering order of “0”, the procedure advances to Step S20 and image element A0 is registered as a new group (Call 1) at the beginning of the ordered list. In Step S22, the scanning of all the image elements is not complete, as a result of which the procedure goes back to Step S10, and the next image element A1 is configured as the target to be scanned. In Step S12, “1” is extracted as the rendering order and “additive alpha-blending” is extracted as the rendering condition of image element A1 of image object P0. In Step S14, due to the fact that image element A1 currently being scanned is the first element to be scanned among the image elements having the same rendering order of “1”, the procedure advances to Step S20 and image element A1 is registered as a new group (Call 2) subsequent to image element A0 of the ordered list. In Step S22, the scanning of all the image elements is not complete, as a result of which the procedure goes back to Step S10, and the next image element A2 is configured as the target to be scanned. In Step S12, “2” is extracted as the rendering order and “multiplicative alpha-blending” is extracted as the rendering condition of image element A2 of image object P0. In Step S14, due to the fact that image element A2 currently being scanned is the first element to be scanned among the image elements having the same rendering order of “2”, the procedure advances to Step S20 and image element A1 is registered as a new group (Call 3) subsequent to image element A1 of the ordered list. In Step S22, the scanning of all the image elements is not complete, as a result of which the procedure goes back to Step S10, and the next image element A3 is configured as the target to be scanned. In Step S12, “3” is extracted as the rendering order and “additive alpha-blending” is extracted as the rendering condition of image element A3 of image object P0. In Step S14, due to the fact that image element A3 currently being scanned is the first element to be scanned among the image elements having the same rendering order of “3”, the procedure advances to Step S20 and image element A3 is registered as a new group (Call 4) subsequent to image element A2 of the ordered list. In Step S22, the scanning of all the image elements is not complete, as a result of which the procedure goes back to Step S10, and image element A0 of the next image object P1 is configured as the target to be scanned. At this point, the ordered list looks as shown in FIG. 5(a).

In Step S12, “0” is extracted as the rendering order and “multiplicative alpha-blending” is extracted as the rendering condition of image element B0 of image object P1. In Step S14, due to the fact that the image elements having the same rendering order of “0” as image element B0 currently being scanned have the same rendering condition as the group (Call 1) to which image element A0 belongs, the procedure advances to Step S16. In Step S16, the image element A0 belonging to the group (Call 1) and image element B0 currently being scanned are registered in the ordered list so as to be rendered using the same rendering process. At this point, the ordered list looks as shown in FIG. 5(b). In Step S22, the scanning of all the image elements is not complete, as a result of which the procedure goes back to Step S10, and the next image element B1 is configured as the target to be scanned.

In Step S12, “1” is extracted as the rendering order and “additive alpha-blending” is extracted as the rendering condition of image element B1 of image object P1. In Step S14, due to the fact that the image elements having the same rendering order of “1” as image element B1 currently being scanned have the same rendering condition as the group (Call 2) to which image element A1 belongs, the procedure advances to Step S16. In Step S16, the image element A1 belonging to the group (Call 2) and image element B1 currently being scanned are registered in the ordered list so as to be rendered using the same rendering process. At this point, the ordered list looks as shown in FIG. 5(c). In Step S22, the scanning of all the image elements is not complete, as a result of which the procedure goes back to Step S10, and the next image element B2 is configured as the target to be scanned.

Processing is carried out in the same manner after image element B2, and the final form of the ordered list is registered as shown in FIG. 5(d). In this image rendering process, the frequency of invoking (calling) the image rendering process is reduced to 4 times while maintaining the rendering order of the image elements constituting each image object intact. Therefore, the speed of the rendering process can be increased without changing the configuration of the entire image being rendered.

### EXAMPLE 2 OF IMAGE RENDERING PROCESS

This example will be described with reference to a case in which the rendering condition of image element C1 of image object P2, which is “additive alpha-blending”, is changed to a different rendering condition, i.e., “multiplicative alpha-blending”. In such a case, processing up to the point when image element C1 of image object P2 is the target of scanning is similar to the above-described Example 1 and will therefore not be discussed further.

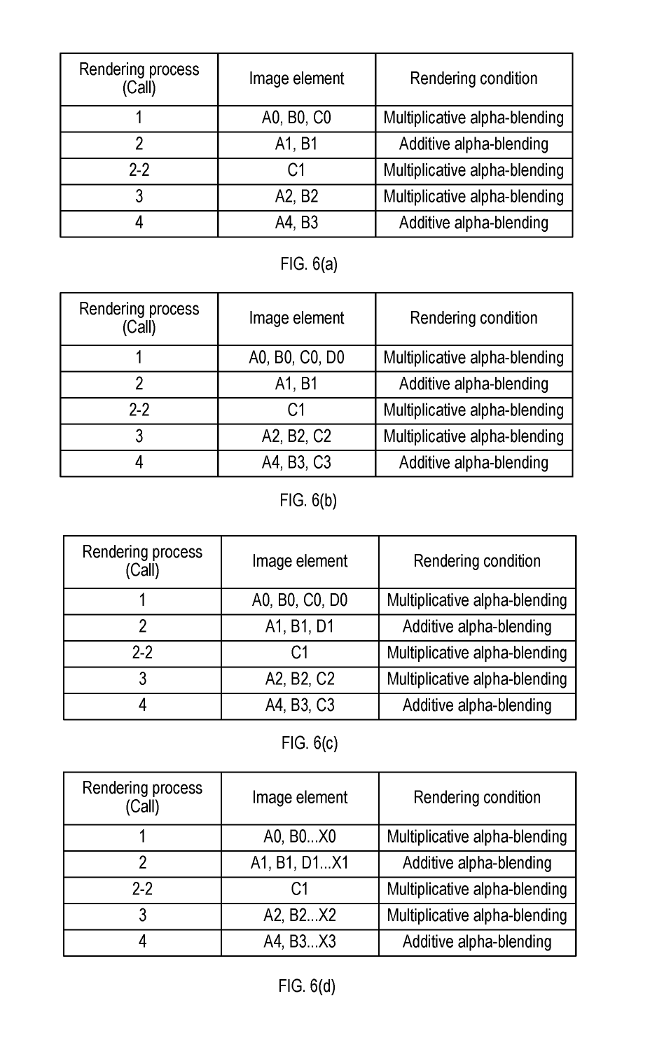

In Step S12, “1” is extracted as the rendering order and “multiplicative alpha-blending” is extracted as the rendering condition of image element C1 of image object P2. In Step S14, due to the fact that the image elements having the same rendering order of “1” as image element C1 currently being scanned do not include any groups having the same rendering condition, the procedure advances to Step S18. In Step S18, the image element C1 currently being scanned is registered in the ordered list subsequent to group 2 of the latest image element B1 being scanned among the image elements having the same rendering order of “1” as image element C1 currently being scanned so as to be rendered as a new group 2-2. At this point, the ordered list looks as shown in FIG. 6(a). In Step S22, the scanning of all the image elements is not complete, as a result of which the procedure goes back to Step S10, and the next image element C2 is configured as the target to be scanned.

Subsequently, from image element C2 of image object P2 to image element D0 of image object P3, processing is carried out in the same manner as in the above-described Example 1. At this point, the ordered list looks as shown in FIG. 6(b).

When the image element D1 of image object P3 is the target of scanning, in Step S12 “1” is extracted as the rendering order and “additive alpha-blending” is extracted as the rendering condition of image element D1 of image object P3. In Step S14, due to the fact that the image elements having the same rendering order of “1” as image element D1 currently being scanned include group 2 having the same rendering condition, the procedure advances to Step S16. In Step S16, the image elements having the same rendering order of “1” as image element D1 currently being scanned are registered in the ordered list so as to be rendered in accordance with the rendering process used for group 2, which has the same rendering condition. At this point, the ordered list looks as shown in FIG. 6(c). In Step S22, the scanning of all the image elements is not complete, as a result of which the procedure goes back to Step S10, and the next image element D2 is configured as the target to be scanned.

Subsequently, starting from the image element D2 of image object P3, processing is carried out in the same manner as in the above-described Example 1. In its final form, the ordered list looks as shown in FIG. 6(d).

### DESCRIPTION OF REFERENCE NUMERALS

10 Processing module
12 Storage module
14 Input module
16 Output module
18 Communication module
100 Image rendering device

1. An image rendering device that renders an image by combining multiple image objects that are represented by superimposing multiple image elements having a preset rendering order, wherein
said image rendering device performs rendering using the same rendering process by compiling image elements that satisfy a combination of rendering conditions, which allow for the rendering using the rendering process that is the same as the respective rendering processes for the multiple image objects.

2. The image rendering device according to claim 1, wherein
the rendering conditions include at least one of texture rendering conditions, alpha-blending rendering conditions, and color-blending rendering conditions.

3. The image rendering device according to claim 2, wherein
the image is rendered such that the rendering order of the multiple image elements contained in each of the multiple image objects is maintained intact.

4. A non-transitory computer readable medium having machine-executable instructions with which a computer having a storage and a hardware processor, for rendering an image by combining multiple image objects that are represented by superimposing multiple image elements having a preset rendering order, the instructions comprising:
performing rendering using a rendering process by compiling image elements that satisfy a combination of rendering conditions, which allow for the rendering using the rendering process that is the same as the respective rendering processes for the multiple image objects.
